(19) United States
(12) Patent Application Publication
(10) Pub. No.: US 2025/0245443 A1
(43) Pub. Date: Jul. 31, 2025

(54) AUTOMATING ADAPTER SELECTION FOR USING LARGE LANGUAGE MODELS IN TASK-AGNOSTIC SCENARIO

(71) Applicant: Dell Products L.P., Round Rock, TX (US)

(72) Inventors: Isabella Costa Maia, São Paulo – SP (BR); Iam Palatnik de Sousa, Rio de Janeiro (BR); Karen Braga Enes, Belo Horizonte – MG (BR); Karen Stéfany Martins, Belo Horizonte – MG (BR); Leandro Takeshi Hattori, Campo Grande – MS (BR); Pablo Nascimento da Silva, Niterói – RJ (BR)

(21) Appl. No.: 18/424,378

(22) Filed: Jan. 26, 2024

(51) Int. Cl. G06F 40/40; G06F 40/284

(52) U.S. Cl. CPC G06F 40/40; G06F 40/284

(57) ABSTRACT

One example method includes receiving at a machine learning (ML) model a textual input. An encoded input is generated from the first textual input. A first adapter is selected from an adapter pool by having an associated key that has a highest similarity to the encoded input. Each adapter of the adapter pool is a module that defines a given task to be performed by the ML model and has an associated key. The selected first adapter is appended to the encoded input, to one or more layers of the ML model, or to a combination of the encoded input and the one or more layers. The encoded input is input into the model after the selected adapter has been appended to thereby generate a first textual output according to an intent of the first textual input.

### FIELD OF THE INVENTION

Embodiments of the present invention generally relate to training of machine learning models. More particularly, at least some embodiments of the invention relate to systems, hardware, software, computer-readable media, and methods for training large language models in a task-agnostic scenario.

### BACKGROUND

Recent research in Large Language Models (LLMs) focuses on enabling the adaptation of pre-trained language models (PLMs) to perform various downstream tasks without finetuning all the model's parameters. While fine-tuning the PLM can be often prohibitively costly, several techniques such as Prompt Tuning, P-tuning, and Prefix-Tuning train only a small number of parameters and keep the base PLM frozen. Besides reducing drastically both the training time and computational resources required, these techniques can sometimes even enhance the model's performance compared to traditional fine-tuning.

Each of these techniques works by concatenating a set of virtual tokens to the input embedding and/or internal PLM's layers. These virtual tokens are learned using a small set of task-specific annotated data and, once the training is over, they remain as a fixed appended set of weights of the PLM for the specific task for which it was trained.

Even if these techniques are highly performant, they all depend on the manual selection of a prompt specifically trained for the task on hand. In currently known solutions, changing the input task requires not only the user to choose the proper prompt, but it also sometimes demands additional changes in the base model (e.g., inclusion of classification head in the transformer for the sequence of a classification task). However, in real-life situations, as a generic large text corpus, a user may not explicitly know the task to be performed for each model's input, which can be numerous and therefore difficult to be exhaustively listed, thus making it difficult to manually select a proper prompt. Thus, each of these techniques is unable to build a PLM that, with only minor changes to the model is able to automatically respond to a generic text input, where: (1) a single text document might contain multiple tasks to be addressed at the same time and there is a desire to address each of the tasks, (2) it is unknown explicitly the corresponding task of each input, (3) it is unknown when the task changes occur in the document, all while not requiring manual user identification of each input's corresponding task nor the entire model retraining.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIGS. 1A-1D disclose aspects of a model for performing the embodiments disclosed herein;

FIG. 2 discloses aspects of training datasets for training an adapter according to the embodiments disclosed herein;

FIG. 3 discloses a method according to an embodiment; and

FIG. 4 discloses an example computing entity configured to perform any of the disclosed methods, processes, and operations.

### DETAILED DESCRIPTION OF SOME EXAMPLE EMBODIMENTS

Embodiments of the present invention generally relate to training of machine learning models. More particularly, at least some embodiments of the invention relate to systems, hardware, software, computer-readable media, and methods for training large language models in a task-agnostic scenario.

One example method includes receiving at a machine learning (ML) model a textual input. An encoded input is generated from the first textual input. A first adapter is selected from an adapter pool by having an associated key that has a highest similarity to the encoded input. Each adapter of the adapter pool is a module that defines a given task to be performed by the ML model and has an associated key. The selected first adapter is appended to the encoded input, to one or more layers of the ML model, or to a combination of the encoded input and the one or more layers. The encoded input is input into the model after the selected adapter has been appended to thereby generate a first textual output according to an intent of the first textual input.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that adapters that have been trained for a given task are retained in an adapter pool and thus are not forgotten by the model. In addition, the adapters can be appended to the model when the task defined by a trained adapter in detected in incoming input without having to make major changes to the underlying structure of the model. This allows the model to operate in task-agnostic scenarios where the model does not know ahead of time the task to be performed.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

The embodiments disclosed herein provide a framework and method that automatically responds to shifting tasks by selecting the most relevant trained adapter to perform a downstream task for a given model's input. The framework implements a pool of adapters, each of them trained for a specific task and associated to a key.

The framework defines a Pre-Trained Language model (PLM) and an adapter method for a Large Language Model (LLM) or other reasonable machine learning (ML) model incorporating the PLM. Importantly, the PLM is pretrained on either Causal Language Modelling (next token prediction, such as GPT-type models) or sequence to sequence multi-tasking (such as T5-type models). These types of models can generally perform various NLP tasks using a single neural network architecture without specific task-related layers. This requirement removes the need for real-time architecture changes (such as the addition of such extra layers, for instance) at the base model.

### Training

The embodiments disclosed herein train an adapter pool which happens in two stages:

### Adapter Training

Consider that, in an initial setup, there is a set of N existing tasks. For each task, the framework holds an annotated set and trains N times a new adapter from scratch. Each of the N trained adapters is put into the adapter pool and assigned to a random key.

### Keys Training

Once the adapters hold semantic meaning, the random keys are trained by minimizing a loss function, here designed as a score (e.g., cosine distance) that quantifies the match between the key and a query, which is a projection of the model's input. The corresponding closest key is updated to match the feature of the input instance via the loss function, such that this key becomes “closer” to examples from the task on hand than other keys.

Periodically, as a predefined amount of new data arrives to the model (or after a predefined period of time), the adapters/keys can be retrained or more adapters can be included in the adapter pool aiming at addressing new tasks within the same model or inducing a more precise match for each of the tasks.

### Inference

At inference time, each time an input arrives to the LLM, it is projected into the key space by a feature extractor. The score function is used to measure the match between the projected input and each of the keys in the adapter pool, selecting that with the highest similarity. The corresponding adapter is appended to the PLM and the input in its original form is forwarded to the main module (model+adapter). The LLM should output the intent contained within the input.

The embodiments disclosed herein include, but are not limited to, the following advantageous aspects:
(1) A method that allows an LLM to address multiple tasks using a single model able to learn new ones without forgetting past knowledge, thus avoiding Catastrophic Forgetting or Catastrophic Interference,
(2) A method for automatically identifying the tasks from an LLM stream input (task-agnostic model), allowing the model to react to a multiple-task scenario while not requiring major changes in the base model, and
(3) A lightweight method for automating adapter management for a single LLM-base model

### B. Aspects of Some Example Embodiments

### B.1 Aspects of Selecting and Appending Adapters to a Model

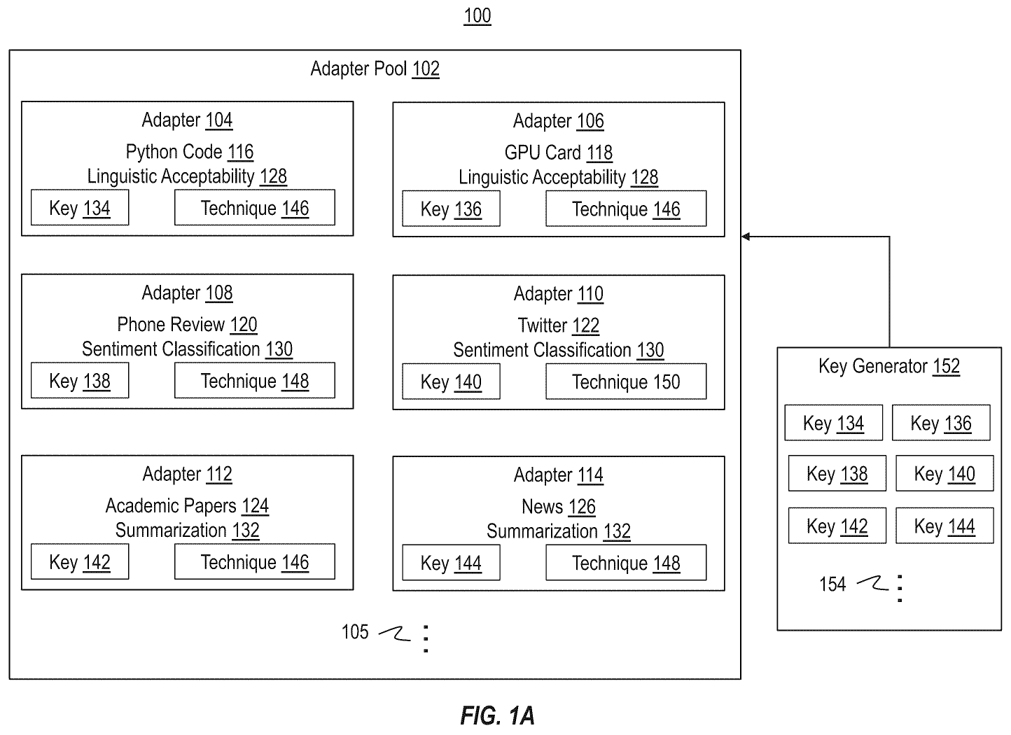

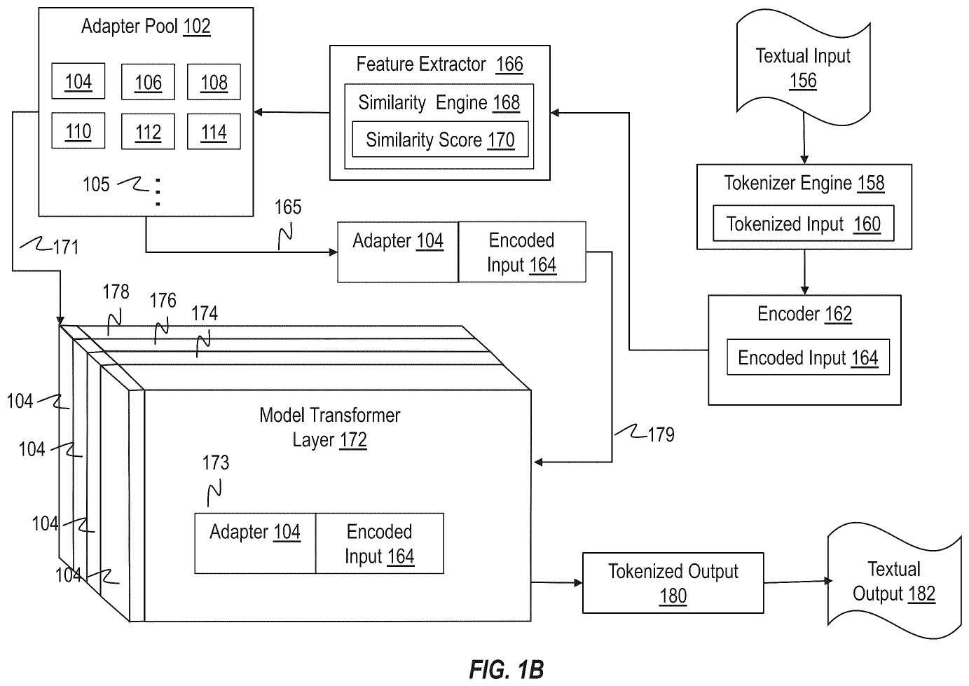

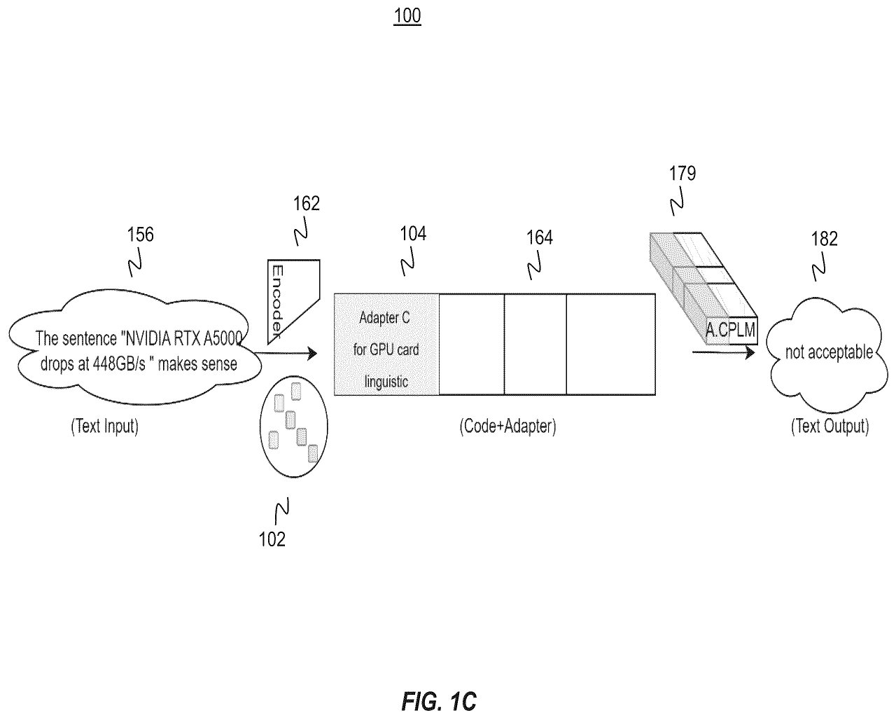

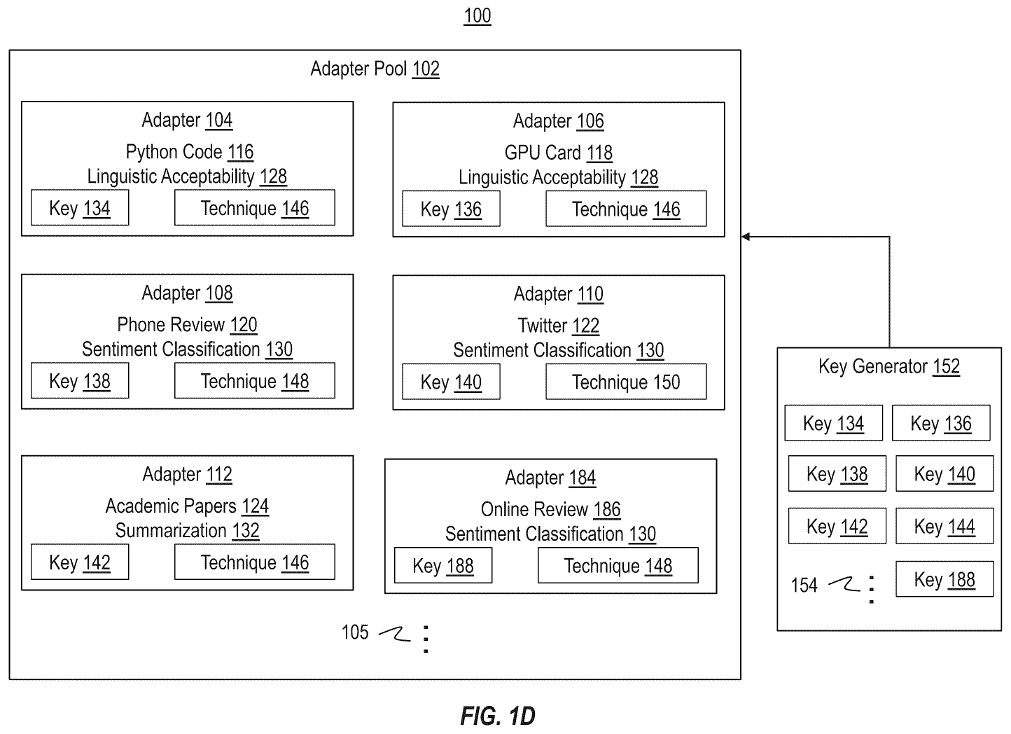

The embodiments disclosed herein implement a new method for creating an LLM, PLM, or other reasonable ML model 100 (all of which are also referred to herein as “the model”) able to automatically handle multiple tasks in a data stream and also to learn new tasks while retaining previously acquired knowledge. FIGS. 1A-1D illustrate an embodiment of the structure and operation of the model 100. The model 100 includes various modules or functional blocks that may implement the various embodiments disclosed herein as will be explained. The various modules or functional blocks of the model 100 may be implemented on a local computing system or may be implemented on a distributed computing system that includes elements resident in the cloud or that implement aspects of cloud computing. The various modules or functional blocks of the model 100 may be implemented as software, hardware, or a combination of software and hardware. The model 100 may include more or less than the modules illustrated in FIGS. 1A-iD and some of the modules may be combined as circumstances warrant. Although not necessarily illustrated, the various modules of the model 100 may access and/or utilize a processor and memory as needed to perform their various functions. In some embodiments, the model 100 may be implemented as a deep learning neural network and the listed functional modules may be implemented as various layer of the neural network. Accordingly, the exact structure of the model 100 is not to be considered limiting to the embodiments disclosed herein.

As illustrated in FIG. 1A, the model 100 includes or otherwise has access to an adapter pool 102 that holds a set of adapters A=(A₁, . . . , A_{N}). Each one of the adapters Aᵢ ∈ A is a small parameter or module that is appended to the model 100 and that are trained to enhance the model's performance for different tasks through different domains. The adapter pool 102 consists of a set of tuples AP={(kᵢ, Aᵢ)}∀ i ∈0 {1, . . . , N}.

For example, the set of adapters A=(A₁, . . . , A_{N}) in the adapter pool 102 includes an adapter 104, an adapter 106, and adapter 108, and adapter 110, and adapter 112, and an adapter 114. The ellipses illustrate the adapter pool may include any number of additional adapters 105 as needed.

Each adapter is small parameter or module that defines or specifies a given task and for the given task, a domain within the task. For example, the adapter 104 specifies a linguistic actability task 128, and within this task a domain 116 of “Python Code.” The adapter 106 specifies the linguistic actability task 128, and within this task a domain 118 of “GPU Card” that is different from the domain of the adapter 104. The adapter 108 specifies a sentiment classification task 130, and within this task a domain 120 of “Phone Review.” The adapter 110 specifies the sentiment classification task 130, and within this task has a domain 122 of “Twitter” that is different from the domain of the adapter 108. The adapter 112 specifies a summarization task 132, and within this task a domain 124 of “Academic Papers.” The adapter 114 specifies the summarization task 132, and within this task a domain 126 of “News” that is different from the domain of the adapter 114.

Thus, adapters can specify different tasks and adapters specifying the same task can specify different domains. In the embodiments, once an adapter is trained as will be explained in more detail to follow, the adapter remains available for use by the model 100 and thus an adapter is not “forgotten” by the model. As will also be explained in more detail to follow, the model 100 is able to implement a given adapter based on a task by making only very minor changes to the underlying structure of the model.

The adapters the adapter pool 102 can be implemented using any reasonable technique known to those of skill in the art, which include trained embedding layers at different parts of the network that are concatenated to encoded input code and, eventually, to the activations of PLM layers, depending on the performance obtained with each of the different techniques. Thus, in the illustrated embodiment the adapters 104, 106, and 112 are implemented using a technique 146, the adapters 108 and 114 are implemented using a technique 148, and the adapter 110 is implemented using a technique 150. Thus, adapters specifying different tasks can be implemented using one technique, while adapters specifying the same task can be implemented by the same or a different technique. As will be explained in more detail to follow, the technique implemented by an adapter is the technique that is the most performative for an adapter during an adapter training phase. In the embodiment, the technique 146 may be a technique where an adapter in vector form is concatenated to encoded input code, the technique 148 may be a technique where the an adapter in vector form is concatenated to one or more model transformer layers, and the technique where an adapter in vector form is concatenated to both the encoded input code and to one or more model transformer layers. Of course, there may be other techniques that are used as operational circumstances warrant.

The model 100 is also characterized by a set of keys k=(kᵢ, . . . , k_{N}). Thus, the model includes or otherwise has access to an a key generator 152. In operation, the key generator generates a set of random keys that are then assigned to each of the adapters in the adapter pool 102. Thus, as illustrated, the key 134 is assigned to the adapter 104, the key 136 is assigned to the adapter 106, the key 138 is assigned to the adapter 108, the key 140 is assigned to the adapter 110, the key 142 is assigned to the adapter 112, and the key 144 is assigned to the adapter 114. The ellipses illustrate that a random keys 154 can also be assigned to any of the additional adapters 105. As will be explained in more detail to follow, the keys are trained so as to bring each key's space closer to its assigned adapter. In this way, as will also be explained in more detail to follow, the keys can be used to select an appropriate adapter for encoded input at inference time.

FIG. 1B illustrates an operation of the model 100 at inference time. As illustrated, the model 100 receives a textual input 156 to be operated on by the model 100. The textual input 156 is received by a tokenizer engine 158 of the model 100, that in operation generates tokenized input 160 according to the properties of the model 100.

The tokenized input 160 is then encoded by an encoder 162 of the model 100. In one embodiment, the encoder 162 may be a Variational Auto-Encoder or a pre-trained transformer. In other embodiments, the encoder 162 may be any other reasonable encoder according to the properties of the model 100. The encoder 162 generates encoded input 164.

The encoded input 164 is provided to a feature extractor 166 that uses the features of the encoded input 164 to determine which of the adapters in the adapter pool 102 should be used in the further processing. In particular, the feature extractor 166 includes a similarity engine 168 that determines a similarity score 170 for the encoded input 164 with respect to each of the keys 134-144. The key with the highest similarity (i.e., highest similarity score 170) to the encoded input 164 is then selected. It will be appreciated that the encoded input 164 in vector form should have the same dimensions as the keys 134-144 in vector form so that the similarity. In one embodiment, the similarity engine 168 uses a dissimilarity function q(code, kᵢ) V kg E k to define a distance such as a cosine distance between the encoded input 164 and each of the keys 134-144. The key with the shortest distance is selected as being most similar to the encoded input 164. The adapter in the adapter pool 102 corresponding to the selected key is then selected to be used in the further process. In the illustrated embodiment, the key 134 is found to have the highest similarity (i.e., highest similarity score 170) to the encoded input 164. Accordingly, the adapter 104 is selected to be used in the further process.

The adapter corresponding to the selected key is then concatenated or appended to the encoded input 164 and/or concatenated or appended to one or more model transformer layers depending on the adapter technique that is implemented by the adapter. For example, in one embodiment as shown at 165 the adapter 104 implements a technique 146 that causes the adapter 104 to be concatenated to the encoded input 164. In another embodiment, as shown at 171 the adapter 104 implements a technique 146 that causes the adapter 104 to be concatenated to the one or more model transformer layers 172, 174, 176, or 178, which may be embedding layers or fully connected layers to the activations of the model 100 and thus the adapter 104 can be appended to one or more embedding layers and/or one or more fully connected layers. In still other embodiments, as shown at 173 the adapter 104 implements a technique 146 that causes the adapter 104 to be concatenated to the one or more model transformer layers 172, 174, 176, or 178 and to the encoded input 164.

The encoded input 164 is then input into the transformer layers as shown at 179. As mentioned, the encoded input 164 may have the adapter 104 appended to it, or the transformer layers may have the adapter 104 appended to one or more of the layers, or a combination of both. In any case, the resulting model will be the model 100 and the adapter 104. In other words, the model 100 has only been changed in a very minor way when appending the adapter 104. The underlying structure of the model 100 has otherwise not been changed. The model 100 having the appended adapter 104 will then output a tokenized output 180, which will then be converted to a textual output 182 according to the intent contained with the textual input 156.

FIG. 1C illustrates a further example embodiment of the operation of the model 100. In this example, some of the elements illustrated in FIG. 1B will be excluded for ease of explanation. In this embodiment, a textual input 156 states “The sentence ‘NVIDIA RTX A5000 drops at 448BG/s’ makes sense” is received by the model 100. The textual input 156 is encoded into encoded input 164 by the encoder 162. In this embodiment, the feature of the textual input 156 “The sentence [ . . . ] makes sense” helps guide the model 100 (i.e., the feature extractor 166) to select an adapter that is able to perform the “linguistic acceptability task” and the feature of the textual input 156 ““NVIDIA RTX A5000 drops at 448 GB/s” helps the model to select an adapter that is related to the domain “GPU card”. In the this embodiment, the adapter 104 is able to perform the “linguistic acceptability task” and is related to the domain “GPU card” and thus is selected.

The adapter 104 is concatenated to the encoded input 164 and then the encoded input code164 is input into the model 100 having the adapter 104 appended to it as shown at 179. The model 100 then output the textual output 182, which in the embodiment is “not acceptable”. Since the intent was to find the acceptability of the sentence contained in the textual input 156, the output “not acceptable” meets this intent and shows a user that the encoded input 164 is not acceptable.

As mentioned, the model 100 is only changed in a very minor way when appending the adapter 104. Further, the adapter 104 remains in the adapter pool 102 and can be used again for new textual inputs having features and intents that are related to the “linguistic acceptability task” and the domain “GPU card and is thus not forgotten by the model 100.

In another embodiment, the model 100 may receive a new textual input having features and intents that are different from the textual inputs 156. In such embodiment, the process described in relation to FIGS. 1A-1C would be repeated for the new input. Specifically, the input would be tokenized and the encoded by the encoder. The feature extractor 166 would determine which of the keys of the adapters in the adapter pool 102 had the highest similarity to the encoded input code and an appropriate adapter would be selected, which in this case would not be adapter 104 since this adapter is not related to the features and intents of the new textual input. Suppose in this embodiment the adapter 110 is selected because the features of the new textual input indicative of the sentiment classification task 130 and the domain “Twitter”. The selected adapter 110 would then be appended to the encoded input code and/or the model transformer layers in the manner previously described. The encoded input code would then be input into the model 100 having the adapter 110 appended to it and the model would output a textual output according to the intent of the new textual input.

This shows that the embodiments disclosed herein allow the model 100 to automatically identify the tasks and domains from the input streams into the model and then to react to these tasks and domains by selecting and appending the appropriate adapter in the manner previous described. Thus, the model 100 is able to operate in task-agnostic scenarios where the model does not know the tasks ahead of time. Further, the model 100 is able to identify and then react to multiple tasks and domains in an input stream such as when a single text document contains multiple tasks that need to be addressed at the same time. In such scenario, the model 100 is able to automatically identify all of the different tasks and domains in the single text document and then select and append appropriate adapters for each task and domain as previously described.

### B.2 Aspects of Adapter Training

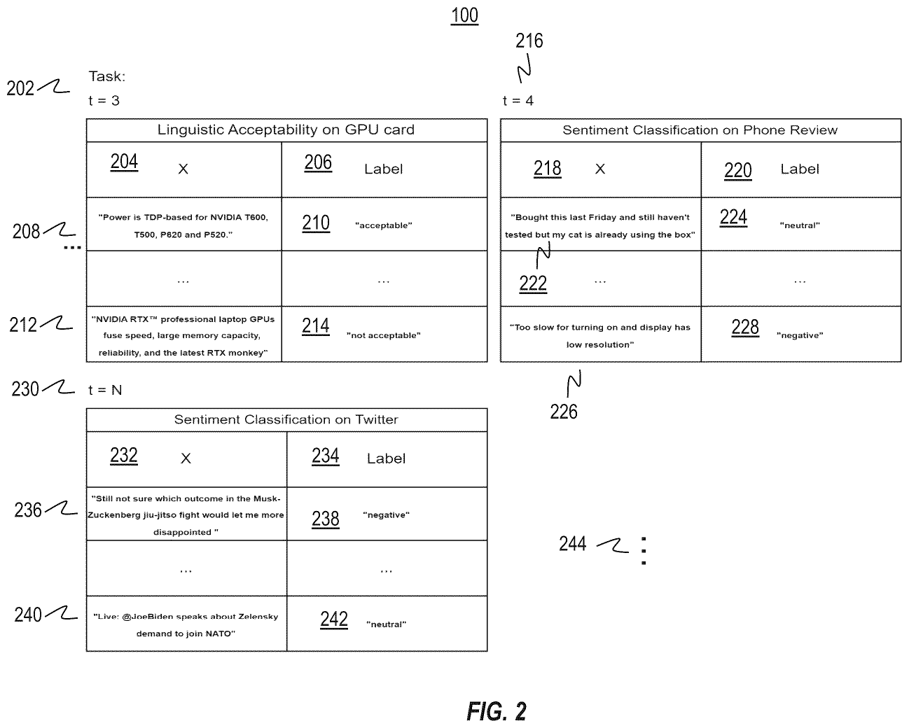

The adapter training process starts by obtaining N training labeled datasets, one for each of the tasks that are intended to be addressed. Since the adapters are a small module to be trained, a few hundreds or thousands of data samples are typically enough for training each of the adapter. FIG. 2 shows an example of a collection of datasets where t ∈ {0, N} is the task-ID of the dataset.

As shown in FIG. 2, a training dataset 202 that has a task-ID t=3 and is for the training an adapter for the task and domain of “linguistic acceptability on GPU card”. The training dataset 202 has input data 204 that has been labeled 206. For example, input data 208 has been labeled by a label 210 and input data 212 has been labeled with a label 214.

Likewise, a training dataset 216 that has a task-ID t=4 and is for the training an adapter for the task and domain of “sentiment classification on phone review”. The training dataset 216 has input data 218 that has been labeled 220. For example, input data 222 has been labeled by a label 224 and input data 226 has been labeled with a label 228.

In addition, a training dataset 230 that has a task-ID t=N and is for the training an adapter for the task and domain of “sentiment classification on Twitter”. The training dataset 230 has input data 232 that has been labeled 234. For example, input data 236 has been labeled by a label 238 and input data 240 has been labeled with a label 242. The ellipses illustrate that there can be any number of additional training datasets 244 as circumstances warrant.

The training process proceeds as follows, given a task t:
1. For each adapter, train this module following the process below:
   a. For each of the adapter techniques (e.g., techniques 146,148, and 150), the general model of FIGS. 1A-1-C built (i.e., include an embedding layer to be appended to the encoded input and/or other embedding layers followed or not by fully connected layers to be appended to the activation layers in the PLM, according to the adapter technique)
   b. Supervised training is performed using part of the labeled dataset (e.g., 202, 216, and 230) from task t (e.g., t=3, t=4, and t=N). In some embodiments, the labeled dataset can include prefixes to the input for helping to lead the model and the key selection to perform the implicit task. As an example, instead of giving “Power is TDP-based for NVIDIA T600, T500, P620 and P520.” as input for the linguistic acceptability task, the model could be fed with “The sentence ‘Power is TDP-based for NVIDIA T600, T500, P620 and P520.’ seems appropriate”
   c. Each adapter's performance is evaluated on a test dataset
2. Keep only the adapter Aₜ, Aₜ being the trained adapter corresponding to most performant adapter technique (e.g., techniques 146,148, and 150) for the given task. Assign adapter Aₜ a randomly generated key kₜ as previously discussed.

The training process should be repeated for every task t ∈ {0, N}, amounting to the adapter set A=(A₁, . . . , A_{N}), which holds semantic meaning for executing the set of tasks at hand.

### B.3 Aspects of Key Training

Since all the keys 134-144 are initialized as random keys, an additional step for helping the model 100 to self-guide the adapter selection from the textual input 156 is performed. Accordingly, an adapter's labeled dataset (e.g., 202, 216, and 230) is used to bring a key's space closer to the encoded input of the dataset, which contains information about the task to be performed. In other words, the keys are updated so that the distance between an encoded input of the dataset for a given adapter and the adapter's assigned key is minimized and the distance between the encoded input of the dataset for the given adapter and the other keys of the key set is increased.

Aₜ this training stage, the keys 134-144 are updated by minimizing the dissimilarity function q(. , .). The loss function for this training stage is defined as Equation 1:

$${min}_{k} {\sum }_{k} q ( code , {k}_{i} )$$

Differently from the adapter's training phase, which is performed using data from one task at a time, a training schedule might be defined that mixes them with a given probability for backpropagating a batch gradient. A continuous transition between tasks has been demonstrated to be beneficial for achieving a better global model performance among tasks. More specifically, a Gaussian Schedule could be implemented where each task follows a Gaussian distribution and is sampled with a given probability at a certain batch iteration. Additionally, at this stage, an ensemble R={Rₜ}∀t ∈ {1, . . . , N} containing some code representatives for each of the tasks (e.g., ˜100 encoder outputs obtained during training of task t) should be kept for a key's retraining in the case of model expansion.

### B.4 Aspects of Incorporating a New Task

If it is desired to incorporate a new task and domain into the model 100 from a labeled dataset, the process described previously for training an adapter can be followed. In other words, an adapter need be trained only for the new task. There is no need for any retraining of the previously trained adapters that the model 100 has already learned.

For example, suppose a new sentiment classification task and domain was for online review. The training process discussed previously would be performed. As shown in FIG. 1D, a new adapter 184 that specifies the sentiment classification task 130, and within this task a domain 186 of “Online Review” could be trained added to the adapter pool 102. The adapter 184 is assigned a random key 188. In addition, as previously discussed, the technique 148 was found to be the most performative for the adapter 184. It will be appreciated that although adapter 114 has been removed from FIG. 1D, this is for ease of illustration only. As mentioned previously, the adapter 114 (and all the adapter) is retained in the adapter pool.

After adding the new adapter 184 to the adapter pool 102, all the keys in the adapter pool will need to be retrained for relocating them in the space considering both the code representatives R and the code samples issued from the new adapter so as to minimize Equation 1 where k=(k₁, . . . , k_{N}, k_{N+1}) and k₁, . . . , k_{N} are the key values obtained from the previous keys training and k_{N+1} is the randomly initialized key 188 obtained after training the new adapter.

In other words, since the keys are trained over encoded inputs of all the tasks, adding the new adapter 184 to the adapter pool may cause some of the distances between a given key and an adapter to change since the new adapter may have better similarity for a given task. Accordingly, all the keys are retrained to minimize Equation 1 anytime a new adapter is added to ensure the distance between the keys and the encoded input is properly calculated.

### C. Example Methods

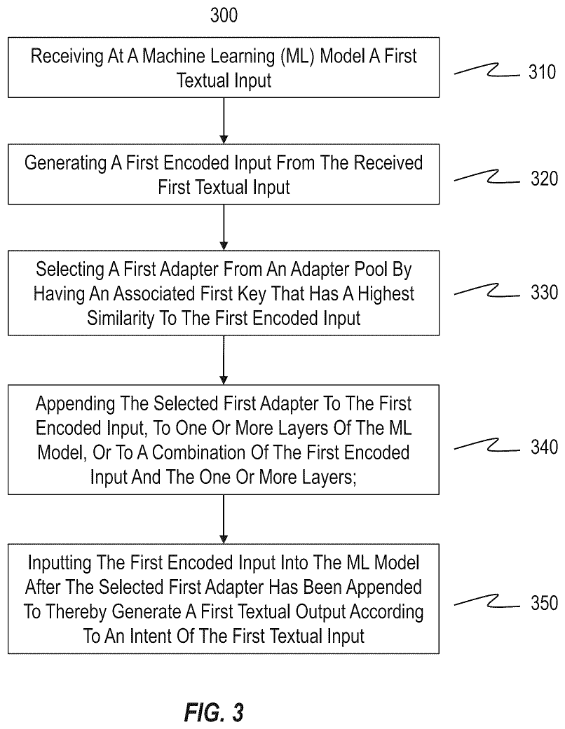

It is noted with respect to the disclosed methods, including the example method 300 of FIG. 3, that any operations of any of these methods, may be performed in response to, as a result of, and/or, based upon, the performance of any preceding operations. Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 3, an example method 300 is disclosed. The method 300 will be described in relation to one or more of the figures previously described, although the method 300 is not limited to any particular embodiment.

The method 300 includes receiving at a machine learning (ML) model a first textual input (310). For example, as previously described the model 100 receives the textual input 156.

The method 300 includes generating a first encoded input from the received first textual input (320). For example, as previously described the encoder 162 generates the encoded input 164.

The method 300 includes selecting a first adapter from an adapter pool having a plurality of adapters, each adapter of the plurality of adapters being a module that defines a given task to be performed by the ML model and having an associated key, the first adapter being selected by having an associated first key that has a highest similarity to the first encoded input (330). For example, as previously described the adapter 104 is selected from the adapter pool 102 for having a key 134 with a highest similarity score 170. As also previously described, each of the adapters 104-114 define a task and a domain in the task and each has an associated key.

The method 300 includes appending the selected first adapter to the first encoded input, to one or more layers of the ML model, or to a combination of the first encoded input and the one or more layers (340). For example, as previously described the adapter 104 is appended or concatenated on the encoded input 164, on one or more of the model transform layers 172-178, or a combination of both.

The method 300 includes inputting the first encoded input into the ML model after the selected first adapter has been appended to the first encoded input, to the one or more layers of the ML model, or to the combination of the first encoded input and the one or more layers to thereby generate a first textual output according to an intent of the first textual input (350). For example, as previously described the encoded input 164 is input into the model 100 after the adapter 104 has been appended to thereby generate the textual output 182 according to an intent of the textual input 156.

### D. Further Example Embodiments

Following are some further example embodiments of the invention. These are presented only by way of example and are not intended to limit the scope of the invention in any way.

Embodiment 1. A method comprising: receiving at a machine learning (ML) model a first textual input; generating a first encoded input from the received first textual input; selecting a first adapter from an adapter pool having a plurality of adapters, each adapter of the plurality of adapters being a module that defines a given task to be performed by the ML model and having an associated key, the first adapter being selected by having an associated first key that has a highest similarity to the first encoded input, appending the selected first adapter to the first encoded input, to one or more layers of the ML model, or to a combination of the first encoded input and the one or more layers; and inputting the first encoded input into the ML model after the selected first adapter has been appended to the first encoded input, to the one or more layers of the ML model, or to the combination of the first encoded input and the one or more layers to thereby generate a first textual output according to an intent of the first textual input.

Embodiment 2. The method as recited in embodiment 1, wherein the one or more layers of the ML model where the selected adapter is appended to are embedding layers and/or fully connected layers to activations in the model.

Embodiment 3. The method as recited in any of embodiments 1-2, wherein the selected first adapter is appended to the encoded input.

Embodiment 4. The method as recited in any of embodiments 1-3, wherein the selected first adapter is retained in the adapter pool after the ML has generated a textual output according to an intent of the textual input.

Embodiment 5. The method as recited in any of embodiments 1-4, wherein each adapter of the adapter pool further defines a domain for each of the defined tasks.

Embodiment 6. The method as recited in any of embodiments 1-5, wherein selecting the first adapter having the associated first key that has a highest similarity to the first encoded input comprises: calculating a dissimilarity function between the first key and the encoded input to thereby find a distance between the first key and the first encoded input in key space.

Embodiment 7. The method as recited in any of embodiments 1-6, wherein each adapter of the plurality of adapters in the adapter pool is trained using a labeled dataset for the given task, the training including determining a most performant adapter technique that defines how each adapter will be appended to the first encoded input, to the one or more layers of the ML model, or to the combination of the first encoded input and the one or more layers.

Embodiment 8. The method as recited in any of embodiments 1-7, wherein each key associated with each adapter of the plurality of adapters in the adapter pool is trained by minimizing a dissimilarity function between the each key and each task defined by each adapter of the plurality of adapters.

Embodiment 9. The method as recited in any of embodiments 1-8, wherein the ML model is a Large Language Model (LLM) or a Pre-Trained Language Model (PLM).

Embodiment 10. The method as recited in any of embodiments 1-9, further comprising: receiving at the ML model a second textual input; generating a second encoded input from the received second textual input; selecting a second adapter from the plurality of adapters in the adapter pool having an associated second key that has a highest similarity to the second encoded input; appending the selected second adapter to the second encoded input, to the one or more layers of the ML model, or to the combination of the second encoded input and the one or more layers; and inputting the second encoded input into the ML model after the selected second adapter has been appended to the second encoded input, to the one or more layers of the ML model, or to the combination of the first encoded input and the one or more layers to thereby generate a second textual output according to an intent of the second textual input.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

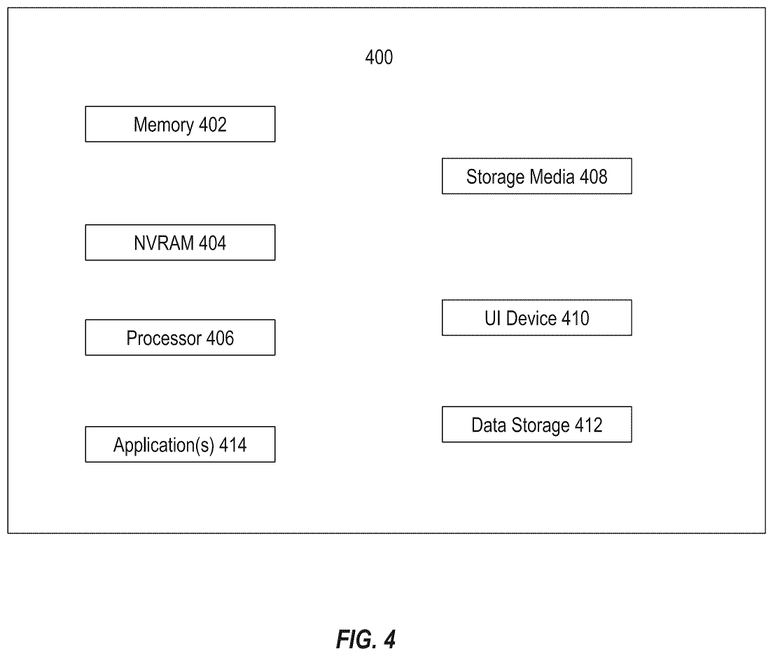

With reference briefly now to FIG. 4, any one or more of the entities disclosed, or implied, by FIGS. 1A-3, and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving at a machine learning (ML) model a first textual input;
generating a first encoded input from the received first textual input;
selecting a first adapter from an adapter pool having a plurality of adapters, each adapter of the plurality of adapters being a module that defines a given task to be performed by the ML model and having an associated key, the first adapter being selected by having an associated first key that has a highest similarity to the first encoded input,
appending the selected first adapter to the first encoded input, to one or more layers of the ML model, or to a combination of the first encoded input and the one or more layers; and
inputting the first encoded input into the ML model after the selected first adapter has been appended to the first encoded input, to the one or more layers of the ML model, or to the combination of the first encoded input and the one or more layers to thereby generate a first textual output according to an intent of the first textual input.

2. The method of claim 1, wherein the one or more layers of the ML model where the selected adapter is appended to are embedding layers and/or fully connected layers to activations in the model.

3. The method of claim 1, wherein the selected first adapter is appended to the encoded input.

4. The method of claim 1, wherein the selected first adapter is retained in the adapter pool after the ML has generated a textual output according to an intent of the textual input.

5. The method of claim 1, wherein each adapter of the adapter pool further defines a domain for each of the defined tasks.

6. The method of claim 1, wherein selecting the first adapter having the associated first key that has a highest similarity to the first encoded input comprises:
calculating a dissimilarity function between the first key and the encoded input to thereby find a distance between the first key and the first encoded input in key space.

7. The method of claim 1, wherein each adapter of the plurality of adapters in the adapter pool is trained using a labeled dataset for the given task, the training including determining a most performant adapter technique that defines how each adapter will be appended to the first encoded input, to the one or more layers of the ML model, or to the combination of the first encoded input and the one or more layers.

8. The method of claim 1, wherein each key associated with each adapter of the plurality of adapters in the adapter pool is trained by minimizing a dissimilarity function between the each key and each task defined by each adapter of the plurality of adapters.

9. The method of claim 1, wherein the ML model is a Large Language Model (LLM) or a Pre-Trained Language Model (PLM).

10. The method of claim 1, further comprising:
receiving at the ML model a second textual input;
generating a second encoded input from the received second textual input;
selecting a second adapter from the plurality of adapters in the adapter pool having an associated second key that has a highest similarity to the second encoded input;
appending the selected second adapter to the second encoded input, to the one or more layers of the ML model, or to the combination of the second encoded input and the one or more layers; and
inputting the second encoded input into the ML model after the selected second adapter has been appended to the second encoded input, to the one or more layers of the ML model, or to the combination of the first encoded input and the one or more layers to thereby generate a second textual output according to an intent of the second textual input.

11. A non-transitory storage medium having stored therein instructions that are executable by one or more hardware processors to perform operations comprising:
receiving at a machine learning (ML) model a first textual input;
generating a first encoded input from the received first textual input;
selecting a first adapter from an adapter pool having a plurality of adapters, each adapter of the plurality of adapters being a module that defines a given task to be performed by the ML model and having an associated key, the first adapter being selected by having an associated first key that has a highest similarity to the first encoded input,
appending the selected first adapter to the first encoded input, to one or more layers of the ML model, or to a combination of the first encoded input and the one or more layers; and
inputting the first encoded input into the ML model after the selected first adapter has been appended to the first encoded input, to the one or more layers of the ML model, or to the combination of the first encoded input and the one or more layers to thereby generate a first textual output according to an intent of the first textual input.

12. The non-transitory storage medium of claim 11, wherein the one or more layers of the ML model where the selected adapter is appended to are embedding layers and/or fully connected layers to activations in the model.

13. The non-transitory storage medium of claim 11, wherein the selected first adapter is appended to the encoded input.

14. The non-transitory storage medium of claim 11, wherein the selected first adapter is retained in the adapter pool after the ML has generated a textual output according to an intent of the textual input.

15. The non-transitory storage medium of claim 11, wherein each adapter of the adapter pool further defines a domain for each of the defined tasks.

16. The non-transitory storage medium of claim 11, wherein selecting the first adapter having the associated first key that has a highest similarity to the first encoded input comprises:
calculating a dissimilarity function between the first key and the encoded input to thereby find a distance between the first key and the first encoded input in key space.

17. The non-transitory storage medium of claim 11, wherein each adapter of the plurality of adapters in the adapter pool is trained using a labeled dataset for the given task, the training including determining a most performant adapter technique that defines how each adapter will be appended to the first encoded input, to the one or more layers of the ML model, or to the combination of the first encoded input and the one or more layers.

18. The non-transitory storage medium of claim 11, wherein each key associated with each adapter of the plurality of adapters in the adapter pool is trained by minimizing a dissimilarity function between the each key and each task defined by each adapter of the plurality of adapters.

19. The non-transitory storage medium of claim 11, wherein the ML model is a Large Language Model (LLM) or a Pre-Trained Language Model (PLM).

20. The non-transitory storage medium of claim 11, further comprising:
receiving at the ML model a second textual input;
generating a second encoded input from the received second textual input;
selecting a second adapter from the plurality of adapters in the adapter pool having an associated second key that has a highest similarity to the second encoded input;
appending the selected second adapter to the second encoded input, to the one or more layers of the ML model, or to the combination of the second encoded input and the one or more layers; and
inputting the second encoded input into the ML model after the selected second adapter has been appended to the second encoded input, to the one or more layers of the ML model, or to the combination of the first encoded input and the one or more layers to thereby generate a second textual output according to an intent of the second textual input.
